(19) United States
(12) Patent Application Publication
(10) Pub. No.: US 2009/0239129 A1
(43) Pub. Date: Sep. 24, 2009

(54) METAL SEPARATOR FOR FUEL CELL

(75) Inventors: Masahiro SEIDO, Tsuchiura-shi (JP); Takaaki SASAOKA, Tsuchiura-shi (JP)

Correspondence Address: Fleit Gibbons Gutman Bongini & Bianco PL, 21355 EAST DIXIE HIGHWAY, SUITE 115, MIAMI, FL, 33180, US

(73) Assignee: HITACHI CABLE, LTD., Tokyo (JP)

(21) Appl. No.: 12/407,299

(22) Filed: Mar. 19, 2009

(30) Foreign Application Priority Data
Mar. 19, 2008 (JP) 2008-072203
Jan. 29, 2009 (JP) 2009-17749

(51) Int. Cl. H01M 2/18

(52) U.S. Cl. 429/39

(57) ABSTRACT

A metal separator for a fuel cell includes a plurality of flow passage grooves for flowing a fluid for operating the fuel cell; manifold holes provided on each side of an upper stream and a lower stream of the plurality of flow passage grooves and formed so as to penetrate a separator made of metal for the fuel cell; communication grooves formed on a separator surface of the separator, for connecting inlets/outlets of the plurality of flow passage grooves and the manifold holes to flow the fluid; a fluid flowing structure part made of metal, in which a through hole is formed on the separator surface that forms the communication grooves, formed in the vicinity of the manifold hole so as to traverse the communication groove; and a flat seal surface formed on the fluid flowing structure part, for sealing a surface of a member that shields an opening of the communication grooves in a state of a face contact.

### BACKGROUND

1. Technical Field

The present invention relates to a metal separator for a fuel cell, and particularly relates to the metal separator for the fuel cell capable of improving a sealing performance in peripheral parts of manifold holes.

2. Description of the Related Art

A metal separator which is thinner and stronger than a graphite separator (having thickness of 2 mm or more) is under development, as a separator for a fuel cell. A metal plate having thickness of 0.1 to 0.2 mm is normally used as the metal separator. In a polymer electrolyte fuel cell, a separator and a membrane electrode assembly (MEA), being a power generation layer (power generator, single cell) of the fuel cell are alternatively laminated to form a stack (cell stack).

If compared with the graphite separator, the metal separator has a thin body in a stacking direction of the separator, and such a thin separator has an advantage that it contributes to realizing a compact stack. In addition, if compared with the graphite separator, the metal separator has characteristics such as toughness in spite of its thin body and ductility, having practically sufficient strength, and capable of surely blocking gas because metal does not allow the gas to pass through.

However, when aiming to make the metal separator compact in a stacking direction of the fuel cell, it is difficult to form a gas flow passage to MEA from manifold holes (through holes penetrating the separator, which are the holes for forming a gas communication path common to the stacked fuel cell, for supplying the gas to each cell in the stacking direction), due to the elasticity of the thin metal separator. This invites an unstable gas sealing of this gas flow passage forming part. As a result, there is a possibility that gas leak occurs and power generation characteristics of the fuel cell are unstable.

Namely, a part between the metal separator and the power generation layer of the fuel cell is normally sealed by providing a soft seal member such as rubber. However, dimension accuracy of the soft member such as rubber is low and its strength is also low, and accordingly the strength of a sealing part in the periphery of the manifold holes is insufficient, thus involving a problem of insufficient seal to thereby cause the gas leak to occur by this insufficient seal.

For example, patent documents 1 to 4 are known as conventional techniques regarding the seal of this kind of separator.

FIG. 9A and FIG. 9B show graphite separators disclosed in patent document 1. FIG. 9A is a plan view of the separator, and FIG. 9B is an expanded sectional view of an essential part of a periphery of the manifold holes of the fuel cell stacked by using the separator. As shown in FIG. 9a and FIG. 9B, in a gas flow structure from manifold holes 101 to a single cell (MEA) 102, communication parts between a flow passage 103 of the separator 100 and the manifold holes 101 are communicatingly connected by a through hole 108 that penetrates to the other surface of the separator 100 from a surface of the separator 100 on which the flow passage 103 is formed, and by a groove 107 for communicating the through hole 108 and the manifold hole 101. In addition, seal materials 105 are provided between a separator 100 and a single cell 102, between a separator 104 and the single cell 102, and between the separator 100 and a separator 106, in the periphery of the manifold hole 101.

FIG. 10 shows a graphite separator disclosed in patent document 2. As shown in FIG. 10, manifold holes 115 and flow passage grooves 111 are formed on a separator 110. The manifold holes 115 and the flow passage grooves 111 are connected to each other by through holes 113 that penetrate to the surface of the opposite side from the surface on which the flow passage grooves 111 of the separator 110 are formed; grooves 114 formed on the surface of the opposite side, for communicating the manifold holes 115 and the through holes 113; and grooves 112 formed on the surface on which the flow passage grooves 111 are formed, for communicating the through holes 113 and the flow passage grooves 111.

FIG. 11 shows the separator using the metal separator having a surface conductive treatment clad layer disclosed in patent document 3. As shown in FIG. 11, the separator is constituted of a metal separator 120 and a resin frame 123. Manifold holes 121 and a plurality of pressed flow passage grooves 122 are formed on the metal separator 120. In addition, manifold holes 121, an opening 124 formed at a position corresponding to a power generator, and inlet grooves 125 formed on the gas flow passage to a plurality of flow passage grooves 122 from the manifold holes 121, are provided on the resin frame 123.

Patent document 4 provides an improved technique of the separator of the patent document 3, and basically sealing performance is increased by forming the resin frame 123 of the patent document 3 into a seal frame. Then, the seal frame is formed by screen-printing a seal material composed of an elastic body such as rubber, on the resin frame 123.

When techniques of the patent document 3 and the patent document 4 are used, a compact separator for a fuel cell can be formed, and cell characteristic of the fuel cell is also stable.

### (Documents of Conventional Techniques)

### (Patent Document 1)

### Japanese Patent Laid Open Publication No. 2002-83614

(Patent document 2)

### Japanese Patent Laid Open Publication No. 2002-298872

(Patent document 3)

### Japanese Patent Publication No. 3723515

(Patent document 4)

### Japanese Patent Laid Open Publication No. 2006-172845

The graphite separator of the patent document 1 and the patent document 2 has a structure in which through holes 108, 113 and grooves 107, 114 are provided on the separator, as a gas flow structure to a power generation layer from the manifold holes. These through holes 108, 113, and the grooves 107, 114 are face-sealed by being covered with the separator 106, etc, for inter-layer sealing. This seal is stable owing to face-sealing. However, in order to perform face-sealing, the separator 106, etc, must be separately added, and when the techniques of the patent document 1 and the patent document 2 are applied to the metal separator, thinness and compactness, which are the characteristics of the metal separator, is halved and cost is increased.

Meanwhile, in the separator disclosed in the patent document 3 and the patent document 4, the resin frame 123 or a seal frame is used, thus involving a problem of incurring a high cost as a result. In addition, projection parts for forming inlet grooves 125 on fringe parts of the manifold holes are provided in the resin frame 123 or the seal frame, to form the flow passage. Therefore, stable sealing performance is not ensured.

Thus, when aiming to make the metal separator compact in the stacking direction of the fuel cell, it is difficult to form the gas flow passage to the power generation layer from the manifold holes, thus making the gas seal unstable in this gas flow passage forming part, because the metal separator is thin and has elasticity. This poses a problem of inviting gas leak and unstable power generation characteristics of the fuel cell.

### SUMMARY OF THE INVENTION

An object of the present invention is to provide a compact metal separator for the fuel cell capable of increasing the sealing performance in the peripheral parts of the manifold holes.

An aspect of the present invention provides a metal separator for a fuel cell, including:

a plurality of flow passage grooves for flowing a fluid for operating the fuel cell;

manifold holes provided on each side of an upper stream and a lower stream of the plurality of flow passage grooves and formed so as to penetrate a separator made of metal for the fuel cell;

communication grooves formed on a separator surface of the separator, for connecting inlets/outlets of the plurality of flow passage grooves and the manifold holes to flow the fluid;

a fluid flowing structure part made of metal, in which a through hole is formed on the separator surface that forms the communication grooves, formed in the vicinity of the manifold hole so as to traverse the communication groove; and

a flat seal surface formed on the fluid flowing structure part, for sealing a surface of a member that shields an opening of the communication grooves in a state of a face contact.

### BRIEF DESCRIPTION OF THE DRAWINGS

FIG. 1A is a plan view of a metal separator for a fuel cell according to a first embodiment of the present invention.

FIG. 1B is a perspective view of a gasket provided on the separator of FIG. 1A.

FIG. 1C is a perspective view of a gasket provided on the separator of FIG. 1A.

FIG. 2 is an exploded perspective view showing a stack of the fuel cell made by using the metal separator for the fuel cell according to the first embodiment.

FIG. 3 is a sectional view of the stack of FIG. 2 cut at a part corresponding to the line A-A of FIG. 1.

FIG. 4A is an expanded plan view of peripheral parts of manifold holes of FIG. 1A, showing an essential part of the separator of FIG. 1A.

FIG. 4B is an expanded sectional view taken along the line R-R of FIG. 4A.

FIG. 4C is an expanded sectional view of FIG. 4A and FIG. 4B taken along the line U1-U1.

FIG. 4D is an expanded sectional view of FIG. 4A and FIG. 4B taken along the line U2-U2.

FIG. 5 is a perspective view showing an expanded periphery of a fluid flowing structure part in the separator of FIG. 1.

FIG. 6 is an arrangement view showing a positional relation in which each part of the stack of FIG. 2 is arranged, with its sectional stacking position aligned.

FIG. 7 is a step view showing the step of making the fluid flowing structure part in the metal separator for the fuel cell according to a second embodiment of the present invention.

FIG. 8 is a perspective view showing the fluid flowing structure part formed by a manufacturing step of FIG. 7 and a part of the separator in its periphery.

FIG. 9A is a plan view of a conventional graphite separator.

FIG. 9B is an expanded sectional view of the periphery of the manifold holes of the fuel cell stacked by using the separator of FIG. 9A.

FIG. 10 is a perspective view showing the conventional graphite separator.

FIG. 11 is an exploded perspective view showing a conventional separator.

### DESCRIPTION OF PREFERRED EMBODIMENTS OF THE INVENTION

Preferred embodiments of the present invention will be described hereunder, based on the drawings.

### First Embodiment

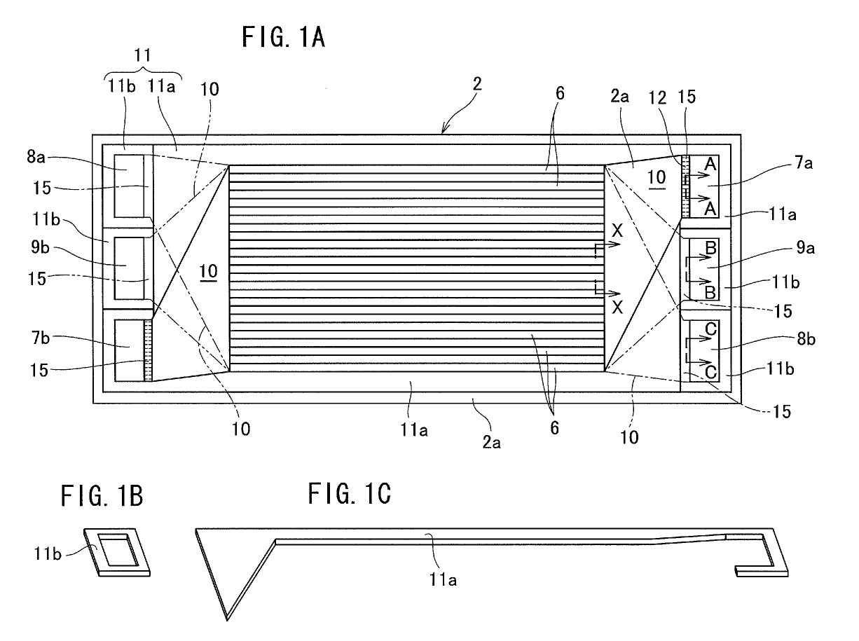

FIG. 1A is a plan view of a metal separator for a fuel cell according to a first embodiment of the present invention. FIG. 1B and FIG. 1C are perspective views of a gasket provided on the separator of FIG. 1A.

As shown in FIG. 1A, a metal separator 2 for the fuel cell is made by using a rectangular metal plate. The metal plate having thickness of, for example, 0.1 to 0.2 mm is used. As a material of the separator 2 made of metal, for example, it is preferable to use a Ti clad material clad with Ti (titanium) on the surface of a metal base material and further subjected to surface conductive treatment.

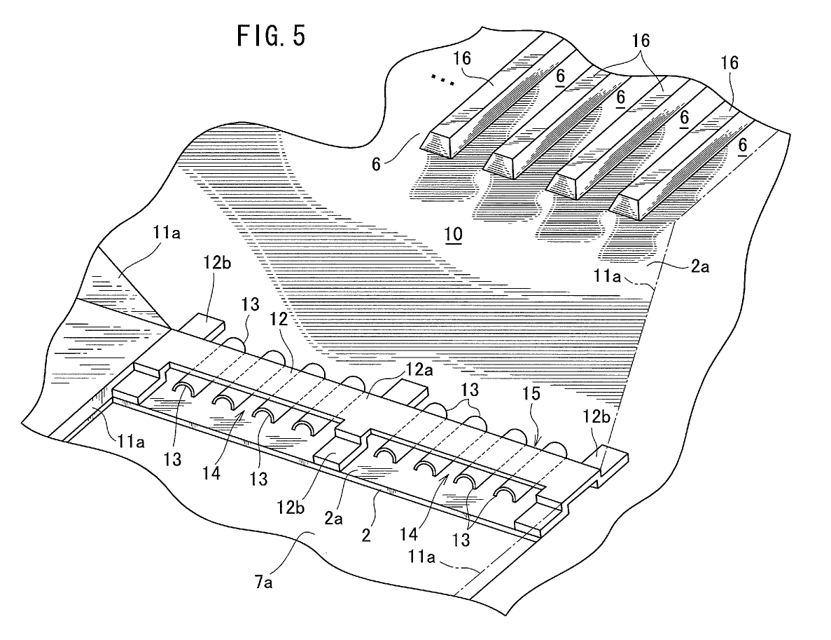

A plurality of flow passage grooves 6, being fluid supply/discharge passages for supplying/discharging a fluid for operating the fuel cell, are formed in a center part of the rectangular separator 2. The plurality of fluid passages grooves 6 are linearly formed in parallel to each other along a direction of a long line of the rectangular separator 2. FIG. 5 is an expanded view of a part of the plurality of flow passage grooves 6, wherein flow passage grooves have a waveform structure with a cross-sectional face formed into a trapezoidal shape, and is molded by press working. A rib 16 is provided between flow passage grooves 6, 6, and a side face of the flow passage groove 6 is formed by the rib 16. Note that when the separator 2 is viewed from a backside, with a separator face 2a of the separator 2 shown in FIG. 5 set as a surface (front surface), the flow passage grooves 6 shown in FIG. 5 constitute ribs, and the ribs 16 constitute the flow passage grooves. A fluid for operating the fuel cell different from that of the front side is flown through the flow passage grooves of the backside.

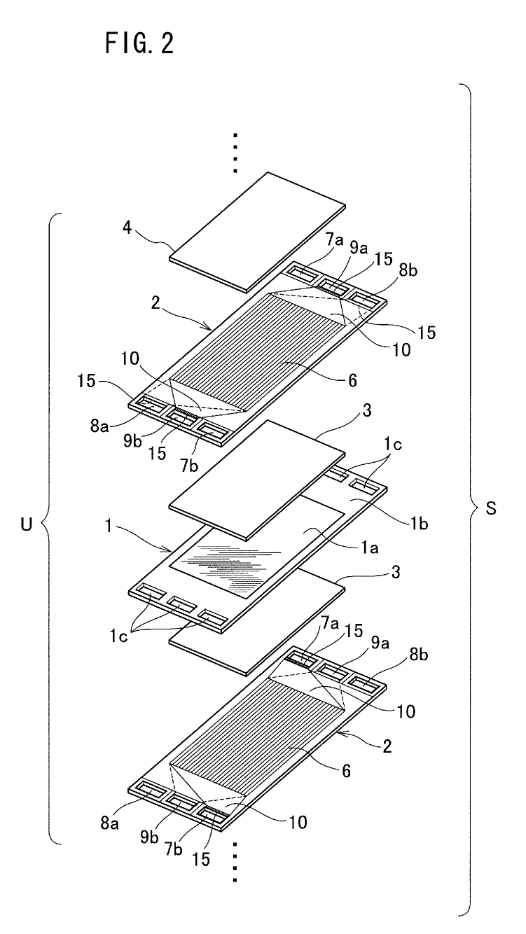

Rectangular manifold holes 7a, 9a, 8b are formed on the separator 2 of one of the inlet/outlet sides of the plurality of flow passage grooves 6, so as to penetrate the separator 2. Also, rectangular manifold holes 8a, 9b, 7b are formed on the separator 2 of the other inlet/outlet side of the plurality of flow passage grooves 6. The manifold holes are the holes for forming the gas communication passage common to the fuel cell, for supplying/discharging the gas to each power generation layer in the stacking direction of the fuel cell in which the separator 2, etc, is stacked (see FIG. 2).

The manifold holes 7a and 7b arranged at diagonal positions of four corner parts of the rectangular separator 2 are the holes for supplying/discharging a fuel gas (such as hydrogen gas). A manifold hole 7a is provided for supplying the fuel gas, and a manifold 7b is provided for discharging the fuel gas. Similarly, the manifold holes 8a and 8b arranged at the diagonal positions are the holes for supplying/discharging an oxidant gas (such as air and oxygen gas). The manifold hole 8a is provided for supplying the oxidant gas, and the manifold hole 8b is provided for discharging the fuel gas. A manifold hole 9a positioned between the manifold holes 7a and 8b, and a manifold hole 9b positioned between the manifold holes 8a and 7b are the manifold holes for supplying/discharging a cooling fluid (such as cooling water). The manifold hole 9a is provided for supplying the cooling fluid, and the manifold hole 9b is provided for discharging the cooling fluid. The fluid for operating the fuel cell is the fuel gas, the oxidant gas, and the cooling fluid.

Communication grooves 10 for flowing the fluid for operating the fuel cell are respectively formed between the inlet/outlet of the plurality of flow passage grooves 6 and the manifold holes 7a, 7b, 8a, 8b, 9a, 9b. The communication grooves 10 shown in solid line in FIG. 1A are formed into the flow passages (diffuser parts) with gradually larger groove width toward the inlet/outlet of the plurality of flow passage grooves 6 from the manifold holes 7a and 7b side. In addition, as shown by chain line in FIG. 1A, the communication grooves 10 for communicatingly connecting the manifold holes 8a, 8b, 9a, 9b and the inlet/outlet of the plurality of flow passage grooves 6, are also formed into a similar expanded flow passages (diffuser parts).

For example, the fuel gas such as the hydrogen gas supplied to the communication grooves 10 from the manifold hole 7a is expandingly flown through the communication grooves 10, then distributed and flown into the plurality of flow passage grooves 6. The fuel gas such as the hydrogen gas flown out from the plurality of the flow passage grooves 6 is merged at the communication groove 10 on the manifold hole 7b side, and flown so as to gradually gather in the communication groove 10, and is discharged from the manifold hole 7b.

A gasket 11, being a seal surface part of the separator 2, is attached to the surface of the separator 2 by adhesive agent, etc. Preferably, the gasket 11 is made by using a material such as resin or rubber, so that no adverse influence is added on the cell characteristics.

The gasket 11 installed on the upper surface of the separator 2 shown in FIG. 1A is constituted of a rectangular annular gasket 11b surrounding an outer peripheral part of the manifold hole (FIG. 1B), and a gasket 11a provided on both sides of the plurality of flow passage grooves 6 (FIG. 1C). The gasket 11b is respectively installed on outer peripheral parts of the manifold holes 8a, 8b, 9a, 9b, on the upper surface of the separator 2 shown in FIG. 1A. The gasket 11a is also a member for separately forming the communication grooves 10, etc, being the flow passages of the fuel gas flowing over the separator 2 of FIG. 1A. The gaskets 11a, 11a are installed so as to surround both sides of the communication grooves 10, 10, both sides of the plurality of flow passage grooves 6, and the outer peripheral part excluding the side of the communication grooves 10, 10 of the manifold holes 7a, 7b. Also, the gasket is similarly provided on the surface of the separator 2 on which the oxidant gas and the cooling fluid is flown.

The upper surface of the separator 2 shown in FIG. 1A is a surface on which the flow passage for flowing the fuel gas such as hydrogen is formed, and fluid flowing structure parts 15, 15 made of metal are provided on the communication grooves 10, 10 positioned on the outer peripheral parts of the manifold holes 7a, 7b for supplying/discharging the fuel gas, so as to traverse the communication grooves 10, 10.

Similarly, the fluid flowing structure parts 15, are provided on the communication grooves 10 positioned on the outer peripheral parts of the manifold holes 8a, 8b, so as to traverse the communication grooves 10, 10, on the surface of the separator 2 on which the flow passage for flowing the oxidant gas such as air is formed. Also, similarly the fluid flowing structure parts 15, 15 are provided on the communication grooves 10, 10 positioned on the outer peripheral parts of the manifold holes 9a, 9b, so as to traverse the communication grooves 10, 10, on the surface of the separator 2 on which the flow passage for flowing the cooling fluid such as cooling water is formed.

The fluid flowing structure parts 15, 15 will be further specifically described. A fluid flowing structure part 15 provided facing the fringe part of the manifold hole 7a will be described hereunder, by using the drawings. However, the fluid flowing structure part 15 installed on the other communication groove 10 has also the same structure.

FIG. 4A is an expanded plan view of the peripheral part of the manifold hole 7a of FIG. 1A, FIG. 4B is an expanded sectional view of FIG. 4A taken along the line R-R, FIG. 4C is an expanded sectional view of FIG. 4A and FIG. 4B taken along the line U1-U1, and FIG. 4D is an expanded sectional view of FIG. 4A and FIG. 4B taken along the line U2-U2. Also, FIG. 5 is a perspective view of the fluid flowing structure part 15 viewed from the manifold hole 7a side.

As shown in FIG. 4A to FIG. 4D, and FIG. 5, the fluid flowing structure part 15 has a seal member 12 of a flat plate shape positioned apart from the separator surface 2a, in parallel to the separator surface 2a of the separator 2 that forms the communication groove 10. Minute gap (flow passage with slit-like cross sections) formed between the seal member 12 and the separator surface 2a is the through hole (flowing hole) 14 through which the fuel gas flowing through the manifold hole 7a passes. The surface of the seal member 12 of the opposite side to the separator surface 2a side is a flat seal surface 12a. The seal surface 12a of the seal member 12 seals a surface of a member for shielding the opening of the communication groove 10 (such as a support frame 1a as will be described later) in a state of a face contact. Attachment parts 12b for attaching the seal member 12 to the separator surface 2a are provided at both ends and in the center of the seal member 12. The seal member 12 is supported by the attachment parts 12b, so as to be apart from the separator surface 2a, and can be formed, for example by folding a plate material for manufacturing the seal member 12 in a step form. The attachment parts 12b are fixed to the separator surface 2a of an outer fringe part of the manifold hole 7a by adhesion or welding.

Reinforcing members 13 for reinforcing the seal member 12 are provided in the through holes 14 between the attachment parts 12b, 12b. The reinforcing members 13 receive a surface pressure such as 10 kg/cm² added to the seal member 12 in the stacking direction (plate thickness direction of the separator 2) at the time of stacking the separator 2, and the seal member 12 is supported thereby in parallel to the separator surface 2a, so as to withstand this seal surface pressure. As shown in FIG. 5 and FIG. 4B, the reinforcing members 13 are sectional arch-like members, with its longitudinal direction provided along the communication groove 10. A plurality of reinforcing members 13 are provided at predetermined intervals in the longitudinal direction of the seal member 12 (groove width direction of the communication groove 10). A convex surface of each reinforcing member 13 is attached and fixed to the seal member 12 by spot welding or adhesion.

Since the reinforcing members 13 are provided in the through holes 14, as shown in FIG. 4B, FIG. 4C, and FIG. 4D, each through hole 14 is constituted of a through hole 14a formed between the reinforcing members 13, 13, and a tunnel-shaped through hole 14b formed between the reinforcing members 13 and the separator 2.

Since a plurality of reinforcing members 13 are provided along the communication groove 10 at predetermined intervals in a groove width direction of the communication groove 10, the gas can be uniformly flown into the communication groove 10 in the groove width direction of the communication groove 10. Further, since the communication groove 10 is a flow passage, with its groove width gradually increasing toward the inlet/outlet side of the flow passage grooves 6, uniformity of a gas pressure in the communication groove 10 is achieved, and the gas, with uniform flow rate, is flown into each flow passage groove 6.

The fluid flowing structure part 15 is a structure having a predetermined rigidity, by providing the attachment part 12b and the reinforcing member 13, on the plate-shaped seal member 12. As a result, deformation of the seal member 12 is restrained, and the sealing performance in the peripheral part of the manifold holes, into which the fluid is supplied/discharged, is considerably improved.

For example, as shown in FIG. 1A, the outer peripheral part of the manifold hole 9a is surrounded by the rectangular annular gasket 11b, and the strength and the sealing performance of the outer peripheral part of the manifold hole 9a is thereby ensured. Meanwhile, although three sides of the outer peripheral part of the manifold hole 7a excluding the communication groove 10 side is surrounded by the gasket 11a, one side of the outer peripheral part of the communication groove 10 side of the manifold hole 7a is opened. However, by providing the fluid flowing structure part 15, being the structure having rigidity, on one side of the outer peripheral part of the communication groove 10 side where no gasket 11a exists, it is possible to create a state such as surrounding four sides of the outer peripheral part of the manifold hole 7a by a gasket, with the through holes 14 opened, and the strength and the sealing performance of the outer peripheral part of the manifold hole 7a is ensured.

Accordingly, sealing failure of the peripheral part of the manifold hole and gas leak can be prevented, and consequently the fuel cell characteristics can be stabilized, by the separator 2 made of metal according to this embodiment.

Note that although the reinforcing member may not be a member with arch-like cross-section, preferably the reinforcing member and the attachment part have a slightly deformable elastic structure, while uniformly supporting the pressure in the surface added to the seal member 12.

The fluid flowing structure part 15 is formed of a metal plate of the same kind or similar kind as that of the separator 2 made of metal, from a viewpoint of strength and chemical stability. Although not surface conductivity is necessary like the separator 2 made of metal, for example Ti (titanium) clad material or Ti plate material is preferably used, and a plate material having a thickness of 0.2 mm or less and 50 μm or more is preferably used. Although smaller thickness is favorable for the plate material for use, provided that the flow passage can be ensured, in a case of an excessively small thickness, the strength is decreased. Therefore the thickness is preferably set at 0.2 mm or less and 50 μm or more.

The fluid flowing structure part 15 of this embodiment is formed separately from the separator 2 and installed on the separator 2. Therefore, a thinner plate material than that of the separator 2 can be used. This makes it possible to optimize a flow passage sectional area of the through hole 14, and also optimize the sealing performance/sealing surface pressure, by appropriately selecting dimension/number of the seal member 12 and the reinforcing member 13. In addition, an attachment position of the fluid flowing structure part 15 on the communication groove 10 can be freely adjusted.

Next, an example of a polymer electrolyte fuel cell using the aforementioned separator 2 will be described. FIG. 2 is an exploded perspective view of the stack of the fuel cell having a lamination structure using the separator 2, etc, of FIG. 1A.

As shown in FIG. 2, a power generation layer (power generation part, cell) 1 of the fuel cell is provided between separators 2, 2. The power generation layer 1 is constituted of a MEA (membrane/electrode assembly) 1a and a support frame 1b for supporting the outer peripheral part of the MEA 1a. The MEA 1a has a sandwich structure, with a polymer electrolyte membrane placed between two electrodes. The polymer electrolyte membrane of the MEA 1a is made of a water-permeable resin, and the support frame 1b is made of a water-impermeable resin.

The support frame 1b is a seal part in a face contact with the gaskets 11a, 11b of the separator 2, and is also a member for forming a power generation flow passage part including a plurality of flow passage grooves 6, and an expanded flow passage including the communication groove 10. Three manifold holes 1c communicating with the manifold holes 7a, 7b, 8a, 8b, 9a, 9b of the separator 2 at the time of laminating the stack, are formed on both sides of the support frame 1b. A diffusion layer 3 of a reaction gas (common designation of the fuel gas and oxidant gas) is provided between the power generation flow passage part of the separator 2 on which a plurality of flow passage grooves 6 are formed, and the MEA 1a. Also, a diffusion layer 4 of a cooling fluid is provided on the opposite side to the diffusion layer 3 side of the separator 2. The diffusion layer 3 and the diffusion layer 4 are manufactured by using a carbon cross and carbon paper, etc. Note that the material of the diffusion layer 4 is not limited to the carbon cross and the carbon paper, and may be a material having conductivity, cushioning property, and not contaminating water.

In FIG. 2, when a laminating direction, in which the separators 2, etc, are laminated, is set as a vertical direction, a unit from the diffusion layer 4 of the cooling fluid to the separator 2 of the lower side as shown in the figure is set as a unit U. Then, by repeatedly vertically laminating this unit U, a stack (cell stack) S of the fuel cell is constituted. The MEA 1a is sandwiched between power generation flow passage parts of the vertical separators 2, and is fastened thereto under a fixed pressure.

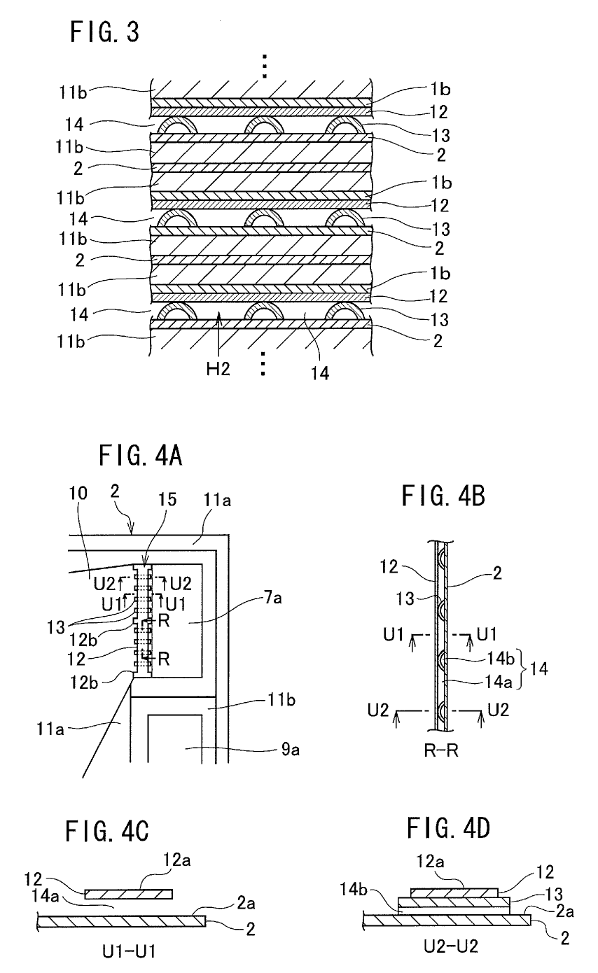

FIG. 3 is a sectional view of the stack of FIG. 2 cut at a part corresponding to the line A-A of FIG. 1. As shown in the figure, seal members 12 are provided on a layer for flowing H₂ gas as a fuel gas, via a plurality of reinforcing members 13 on the separators 2, and the through holes 14 are formed between the separators 2 and the seal members 12, and the H₂ gas is flown into these through holes 14 from the manifold hole. The seal members 12 supported by a plurality of reinforcing members 13 are air-tightly pressed against support frames 1b of the power generation layer at a uniform surface pressure. Layers not allowing the H₂ gas to flow are shielded by the gaskets 11b.

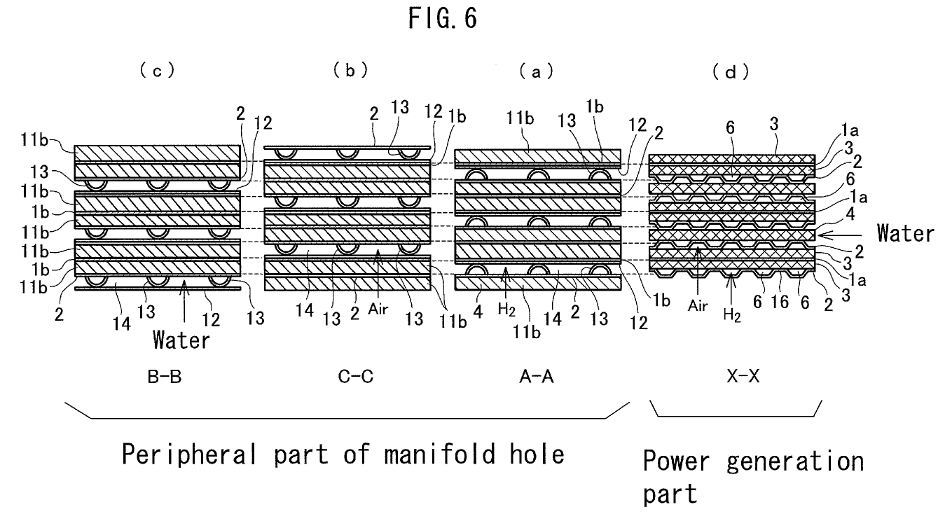

FIG. 6 is an arrangement view showing a positional relation of each sectional part of the stack of FIG. 2, with sectional laminating positions aligned. FIG. 6(a) is a sectional view of a part corresponding to the line A-A of FIG. 1A, FIG. 6(b) is a sectional view of a part corresponding to the line C-C of FIG. 1A, FIG. 6(c) is a sectional view of a part corresponding to the line B-B of FIG. 1A, and FIG. 6(d) is a sectional view of a part corresponding to the line X-X of FIG. 1A.

As shown in (a), (b), (c) of FIG. 6, layers for flowing the H₂ gas, layers for flowing air, and layers for flowing water are respectively formed in the manifold holes 7a, 8b, 9a. Also, as shown in (d) of FIG. 6, the flow passage grooves 6 of the separators 2 for flowing air, and the flow passage grooves 6 of the separators 2 for flowing the H₂ gas are respectively arranged in an upper part and a lower part of the MEA1a, via the diffusion layers 3. The air and H₂ gas are supplied to the MEA1a. Then a cooling layer part having the diffusion layer 4 for flowing cooling water is arranged between the power generation layers sandwiched by upper and lower separators 2.

Next, the flow of the fluid in one unit U shown in FIG. 2 will be described. In this description, the laminating direction, in which the separators 2, etc, of FIG. 2 are laminated, is set as the vertical direction.

Two kinds of reaction gas are used as the fluid for power generation. Here, the H₂ gas is used as the fuel gas, and air is used as the oxidant gas. Also, water is used as the cooling fluid.

The H₂ gas of the fuel gas is flown through the upper surface of the separator 2 positioned on the lower side of the unit U. Namely, the H₂ gas flowing through the manifold hole 7a passes through the fluid flowing structure part 15, then passes through the communication groove 10 on the upper stream side, a plurality of flow passage grooves 6, and the communication groove 10 on the lower stream side, and flows into the manifold hole 7b, and is discharged to outside through the manifold hole 7b. The H₂ gas is supplied to the electrode on the lower side of the MEA1a via the diffusion layer 3, while flowing through a plurality of flow passage grooves 6.

The air of the oxidant gas flows through a lower surface of the separator 2 which is positioned on the upper side of the unit U (air flows through a plurality of flow passage grooves 6 reversely to the H₂ gas). Namely, the air flowing through the manifold hole 8a passes through the fluid flowing structure part 15, then passes through the upper stream side communication groove 10, a plurality of flow passage grooves 6, the lower stream side communication groove 10, and flows into the manifold hole 8b, and is discharged to the outside through the manifold hole 8b. The air is supplied to the electrode on the upper side of the MEA1a via the diffusion layer 3, while flowing through the plurality of flow passage grooves 6.

Water for cooling the fluid flows through an upper surface of the separator 2 positioned on the upper side of the unit U. Namely, the water flowing through the manifold hole 9a flows through the fluid flowing structure part 15, then passes through the communication groove 10 on the upper stream side, the plurality of flow passage grooves 6, and the communication groove 10 on the lower stream side, and flows into the manifold hole 9b on the lower stream side, and is discharged to the outside through the manifold hole 9b. The water is supplied to the diffusion layer 4 while flowing through the plurality of flow passage grooves 6. Also, similarly the water of the cooling fluid flows through the lower surface of the separator 2 positioned on the lower side of the unit U.

A function of the separator is to press the polymer electrolyte membrane of MEA at a constant pressure, then make electric conductivity, and separate the fuel gas flown to the cathode side from the oxidant gas flown to the anode side of the MEA, so as not to be directly mixed with each other. Sealing between the outer peripheral part of the MEA and the separator is relatively easy. However, it is difficult to seal the gas inlet/outlet of the manifold hole, because the layer for the gas to go in and out and a layer for sealing the gas are alternately present in the laminating direction. Therefore, power generation characteristics are greatly influenced, if inlet/outlet of the gas and sealing are not surely performed.

As a specific example of this embodiment, a Ti layer is cladded on the surface of a thin-plate shaped stainless steel (SUS), and further an Au (gold) layer is formed on the Ti layer by nano-level coating using a sputtering method, to thereby form a metal material (clad material M-TST by HITACHI CABLE, having thickness of 0.2 mm). Then, by using this metal material, the separator 2 is formed and the fluid flowing structure part 15, which is formed by using the Ti plate material having thickness of 80 μm, is spot-welded to the separator 2. The stack in which 30 units are laminated, is manufactured by using this separator, and it is found that even under a constant surface pressure (about 10 kg/cm²) during power generation, excellent power generation characteristics without seal leakage can be exhibited.

### Second Embodiment

Next, the metal separator for the fuel cell according to a second embodiment of the present invention will be described.

In the aforementioned first embodiment, the fluid flowing structure part 15 formed separately from the separator 2 is attached to the separator 2. However, in this second embodiment, a fluid flowing structure part 20 is formed by folding, etc, a part of the separator 2. The other structure of the separator 2 is the same as that of the separator 2 according to the first embodiment.

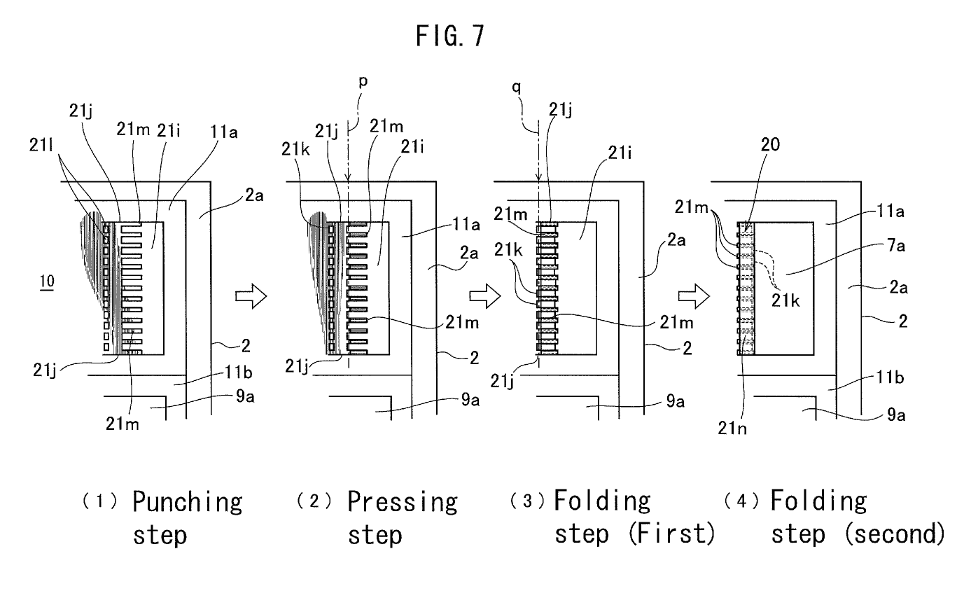

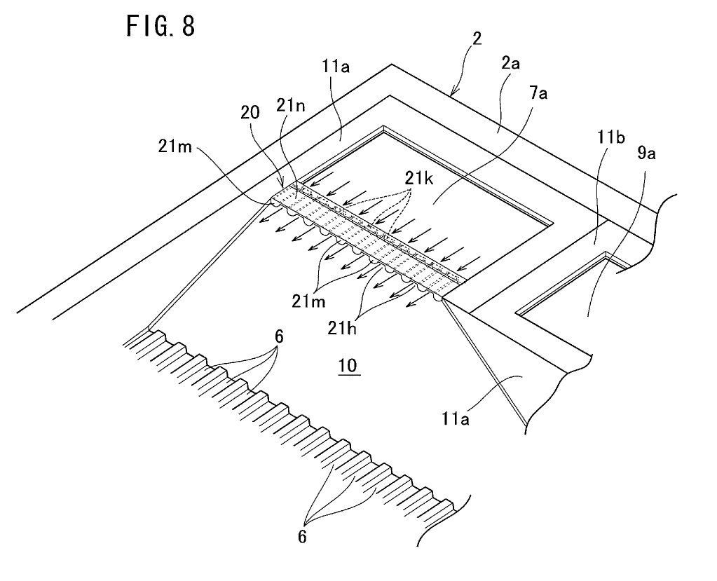

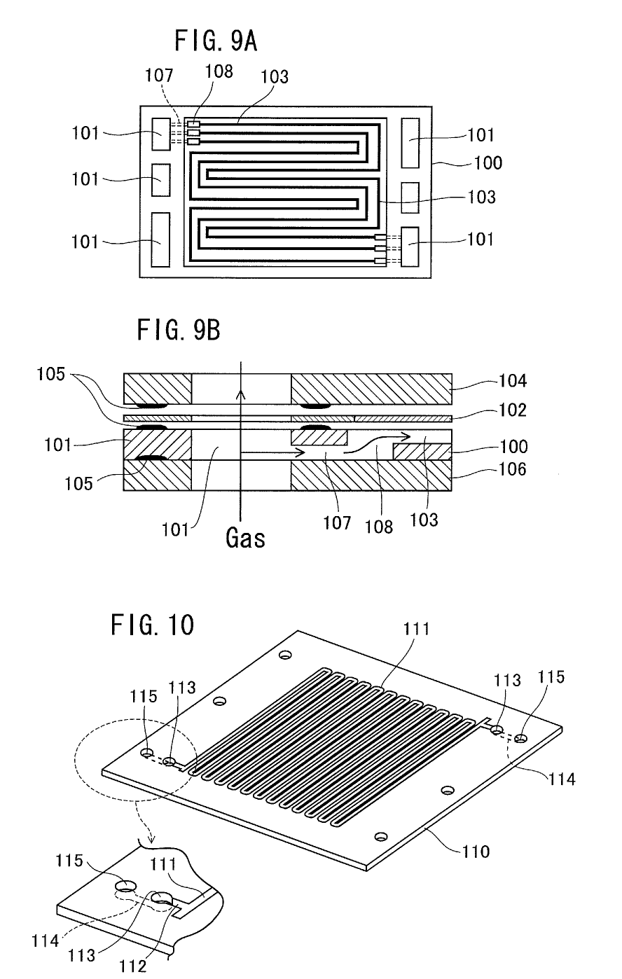

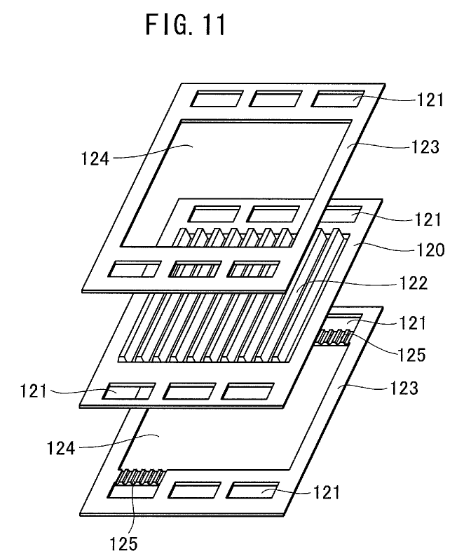

FIG. 7 is a step view showing the step of forming the fluid flowing structure part 20 in the separator of the second embodiment, and FIG. 8 is a perspective view showing the fluid flowing structure part 20 formed by the step of FIG. 7 and its periphery.

Each step will be specifically described by using FIG. 7. Note that FIG. 7 shows a case that the fluid flowing structure part 20 is formed on the fringe part of the manifold hole 7a. However, the fluid flowing structure part 20 is also formed on the fringe parts of other manifold holes 7b, 8a, 8b, 9a, and 9b, in the same step.

### (Punching Step, FIG. 7(1))

In the punching step, an opening part 21i is punched, so that reinforcing parts 21m, being reinforcing members, are arranged in a comb-teeth shape at equal intervals along the groove width direction of the communication groove 10. Simultaneously, slits 21j connected to an opening part 21i are formed on both sides of the communication groove 10 in the groove width direction. The slits 21j are cut into approximately the same dimension as that of the manifold hole 7b formed after a folding step as will be described later. Also, simultaneously with forming the slits 21j, a plurality of holes 21k are formed between end portions of the slits 21j, 21j, along the groove width direction of the communication groove 10. The holes 21k are formed so as to be positioned between the adjacent reinforcing parts 21m at the same intervals as those of the reinforcing parts 21m.

### (Pressing Step, FIG. 7(2))

In the next pressing step, the reinforcing parts 21m are press-molded, and center line parts of the thin and long reinforcing parts 21m are molded into an arch-shape in a state of being sagged downwards of a paper surface of FIG. 7. In this case, root parts of the reinforcing parts 21m are not molded.

### (Folding Step, FIGS. 7(3),(4))

Folding operation is performed twice in the next folding step.

In the first folding step, the reinforcing parts 21m are folded to the communication groove 10 side at about 180° via the upper part of the paper surface of FIG. 7. Each folded reinforcing part 21m is positioned between adjacent holes 21k. In addition, a part of the separator 2 between the slits 21j, 21j in a region where the folded reinforcing parts 21m are present, becomes a seal part 21n for forming a seal surface of the fluid flowing structure part 20 by the next second folding.

In the second folding step, the part of the separator 2 between the slits 21j, 21j where the folded reinforcing parts 21m are present, is folded at about 180° to the communication groove 10 side, with the center line of a plurality of holes 21k set as a folding line q. Thus, a seal part 21n, being the seal member parallel to the separator surface 2a, is formed. The reinforcing parts 21m having arch-like sectional faces, being reinforcing members, are provided between the seal part 21n and the separator surface 2a, and the seal part 21n is supported by the reinforcing parts 21m. In addition, the opening part 21i is expanded by second folding, and the manifold hole 7a is thereby formed.

### (Fixing Step)

This step is performed as needed, in a viewpoint of strength. In the fixing step, a contact point, etc, between each reinforcing part 21m formed by press-molding and the seal part 21n is fixed by spot welding, etc. Note that this fixing step may be performed after the first folding step.

By the above-described step, as shown in FIG. 8, the fluid flowing structure part 20 of this embodiment is formed on the fringe part of the communication groove 10 side of the manifold hole 7a. The gas flowing through the manifold hole 7a passes through holes 21k arranged on the communication groove 10, at equal intervals in a groove width direction, then further passes through through holes 21h connected to the holes 21k, formed between the seal part 21n and the separator surface 2a, and between the adjacent reinforcing parts 21m, and flows into the communication groove 10.

As a specific example of this embodiment, the Ti layer is cladded on the surface of a thin-plate shaped stainless steel (SUS), and further an Au (gold) layer is formed on the Ti layer by nano-level coating using a sputtering method, to thereby form a metal material (clad material M-TST by HITACHI CABLE, having thickness of 0.1 mm). Then, by using this metal material, the separator 2 is formed and the fluid flowing structure part 20 is formed on the Ti layer by punching, pressing, folding, and fixing. The stack, in which 10 units are laminated, is manufactured by using this separator 2, and when a power generation test is performed, excellent power generation characteristics can be obtained.

Note that when the fluid flowing structure parts 15, 20 are installed or formed, after press-molding a plurality of flow passage grooves 6 on the separator 2, or after fitting the gaskets 11a, 11b to the separator 2, the sealing performance is ensured, mass productivity can be realized, and decrease of cost can be expected.

In addition, irrespective of the above-described embodiments, the inventors of the present invention study on a structure that a plurality of projection parts for forming the inlet/outlet grooves or openings are formed on the separator surface of the peripheral parts of the manifold holes, and the upper surface, etc, of these projection parts are sealed. However, the sealing performance in this case is not ensured, and a lot of trouble is taken to perform sealing. Meanwhile, in the structure of the above-described embodiment, assembly of the stack can be efficiently performed, and the sealing performance is ensured.

What is claimed is:

1. A metal separator for a fuel cell, comprising:
a plurality of flow passage grooves for flowing a fluid for operating the fuel cell;
manifold holes provided on each side of an upper stream and a lower stream of the plurality of flow passage grooves and formed so as to penetrate a separator made of metal for the fuel cell;
communication grooves formed on a separator surface of the separator, for connecting inlets/outlets of the plurality of flow passage grooves and the manifold holes to flow the fluid;
a fluid flowing structure part made of metal, in which a through hole is formed on the separator surface that forms the communication grooves, formed in the vicinity of the manifold hole so as to traverse the communication groove; and
a flat seal surface formed on the fluid flowing structure part, for sealing a surface of a member that shields an opening of the communication grooves in a state of a face contact.

2. The metal separator for the fuel cell according to claim 1, wherein the fluid flowing structure part has a flat-shaped seal member provided in parallel to the separator surface for forming the communication groove so as to be apart from the separator surface, the seal member forming the flat seal surface.

3. The metal separator for the fuel cell according to claim 1, wherein a reinforcing member for reinforcing the fluid flowing structure part is provided in the part of the through hole.

4. The metal separator for the fuel cell according to claim 3, wherein the reinforcing member is formed into a sectional arch-like member.

5. The metal separator for the fuel cell according to claim 3, wherein the reinforcing members are provided along the communication groove in a longitudinal direction thereof, and a plurality of reinforcing members are arranged at predetermined intervals in a transverse direction of the communication groove.

6. The metal separator for the fuel cell according to claim 1, wherein the fluid flowing structure part is formed separately from the separator, and is attached to the communication groove.

7. The metal separator for the fuel cell according to claim 1, wherein the fluid flowing structure part is formed by processing including folding of a part of the separator.

8. The metal separator for the fuel cell according to claim 1, wherein the fluid passage grooves have a cross-sectional face having a continuous trapezoidal waveform structure.

9. The metal separator for the fuel cell according to claim 1, wherein the communication grooves have a width gradually increasing toward inlet/outlet sides of the plurality of flow passage grooves from the manifold holes side.

10. The metal separator for the fuel cell according to claim 1, wherein both side faces of the communication groove are formed by gaskets attached to the surface of the separator.

11. The metal separator for the fuel cell according to claim 1, wherein a Ti plate material or a Ti clad material having thickness of 50 μm or more and 0.2 mm or less is used in the fluid flowing structure part.
